(19) United States
(12) Patent Application Publication
(10) Pub. No.: US 2026/0341013 A1
(43) Pub. Date: Oct. 29, 2026

(54) INFORMATION PROCESSING SYSTEM, INFORMATION PROCESSING METHOD, AND NON-TRANSITORY COMPUTER-READABLE MEDIUM

(71) Applicant: NEC Corporation, Minato-ku, Tokyo (JP)

(72) Inventor: Ryuichi AKASHI, Tokyo (JP)

(73) Assignee: NEC Corporation, Minato-ku, Tokyo (JP)

(21) Appl. No.: 19/121,458

(22) PCT Filed: Nov. 1, 2022
(86) PCT No.: PCT/JP2022/040864

§ 371 Date: Apr. 16, 2025

(51) Int. Cl. G06V 10/98; G06V 10/82; G06V 40/19; H04N 23/60; H04N 23/611

(52) U.S. Cl. CPC G06V 10/993; G06V 10/82; G06V 40/19; H04N 23/611; H04N 23/64

(57) ABSTRACT

An information processing system (50) includes a camera (20), an acquisition unit (110), an estimation unit (130), and a control unit (150). The camera (20) is capable of capturing an image of a target. The acquisition unit (110) acquires state information indicating at least a state of the target. The estimation unit (130) generates degradation information by use of the state information. The degradation information is information relating to degradation estimated to occur in a target image acquired by capturing an image of the target with the camera (20).

The control unit (150) outputs control information according to the degradation information at at least one of times before an image of the target is captured with the camera (20) and at which ani image of the target is captured with the camera (20).

### TECHNICAL FIELD

The present disclosure relates to an information processing system, an information processing apparatus, an information processing method, and a medium.

### BACKGROUND ART

A variety of recognition systems using an image of a target have been developed. In such a system, it is necessary to acquire a good image of the target.

Patent Document 1 describes measuring, from a face component distance, an actual distance between a person to be photographed and a camera, and acquiring an eye image from a person image of the person to be photographed who has been confirmed to be in an iris capture photography space. Further, Patent Document 1 describes measuring quality of the acquired eye image, and acquiring an image for iris recognition satisfying a criterion quality degree.

Patent Document 2 describes evaluating quality of an iris image before processed for iris recognition. Moreover, Patent Document 2 describes that an evaluation of the iris image is provided according to blur, defocus, eye closure, obscuration, and the like.

Patent Document 3 describes that, in walk-through recognition, focus is fixed on and burst imaging is performed on a target person passing through a fixed focal position, and, in a case of re-recognition, focus is scanned and burst imaging is performed on a target person standing still. In this way, a technique in Patent Document 3 enables extracting an iris image focused on an iris of the target person.

### RELATED DOCUMENTS

### Patent Documents

Patent Document 1: Japanese Patent Application Publication (Translation of PCT Application) No. 2017-503276

Patent Document 2: Japanese Patent Application Publication (Translation of PCT Application) No. 2009-529200

Patent Document 3: International Patent Publication No. WO 2021/199188

### SUMMARY

### Technical Problem to be Solved

This disclosure aims to ameliorate techniques described in the related documents described above.

### Solution to Problem

According to one aspect of this disclosure, there is provided an information processing system including:
a camera being capable of capturing an image of a target;
an acquisition unit that acquires state information indicating at least a state of the target;
an estimation unit that generates, by use of the state information, degradation information relating to degradation estimated to occur in a target image acquired by capturing an image of the target with the camera; and
a control unit that outputs control information according to the degradation information at at least one of times before an image of the target is captured with the camera and at which an image of the target is captured with the camera.

According to one aspect of this disclosure, there is provided an information processing apparatus including:
an acquisition unit that acquires state information indicating at least a state of a target;
an estimation unit that generates, by use of the state information, degradation information relating to degradation estimated to occur in a target image acquired by capturing an image of the target with a camera; and
a control unit that outputs control information according to the degradation information at at least one of times before an image of the target is captured with the camera and at which an image of the target is captured with the camera.

According to one aspect of this disclosure, there is provided an information processing method including,
by one or more computers:
   acquiring state information indicating at least a state of a target;
   generating, by use of the state information, degradation information relating to degradation estimated to occur in a target image acquired by capturing an image of the target with a camera; and
   outputting control information according to the degradation information at at least one of times before an image of the target is captured with the camera and at which an image of the target is captured with the camera.

According to one aspect of this disclosure, there is provided a computer-readable medium storing a program,
the program causing a computer to function as:
   an acquisition unit that acquires state information indicating at least a state of a target;
   an estimation unit that generates, by use of the state information, degradation information relating to degradation estimated to occur in a target image acquired by capturing an image of the target with a camera; and
   a control unit that outputs control information according to the degradation information at at least one of times before an image of the target is captured with the camera and at which an image of the target is captured with the camera.

### BRIEF DESCRIPTION OF THE DRAWINGS

FIG. 1 It is a diagram illustrating an outline of an information processing system according to a first example embodiment.

FIG. 2 It is a diagram illustrating an outline of an information processing apparatus according to the first example embodiment.

FIG. 3 It is a diagram illustrating an outline of an information processing method according to the first example embodiment.

FIG. 4 It is a diagram illustrating a usage environment of the information processing system according to the first example embodiment.

FIG. 5 It is a block diagram illustrating a functional configuration of an information processing system according to the first example embodiment.

FIG. 6 It is a flowchart illustrating a flow of processing performed by the information processing system according to the first example embodiment.

FIG. 7 It is a diagram illustrating a degradation estimation model used by an estimation unit for generation of degradation information.

FIG. 8 It is a diagram illustrating a computer for achieving an information processing apparatus.

FIG. 9 It is a diagram illustrating a functional configuration of an information processing system according to a second example embodiment.

FIG. 10 It is a flowchart illustrating a flow of processing executed by an information processing system according to a third example embodiment.

FIG. 11 It is a diagram illustrating a quality estimation model used by a control unit for generation of a quality score.

FIG. 12 It is a block diagram illustrating a functional configuration of an information processing system according to a fourth example embodiment

FIG. 13 It is a diagram for describing a method in which an estimation unit according to a sixth example embodiment generates degradation information.

FIG. 14 It is a block diagram illustrating a functional configuration of an information processing system according to a seventh example embodiment.

FIG. 15 It is a diagram illustrating a usage environment of the information processing system according to the seventh example embodiment.

FIG. 16 It is a block diagram illustrating a functional configuration of an information processing system according to an eighth example embodiment.

### EXAMPLE EMBODIMENTS

Hereinafter, example embodiments of this disclosure are described by use of the drawings. Note that, in all of the drawings, a similar component is assigned with a similar reference sign, and description thereof is omitted as appropriate.

### First Example Embodiment

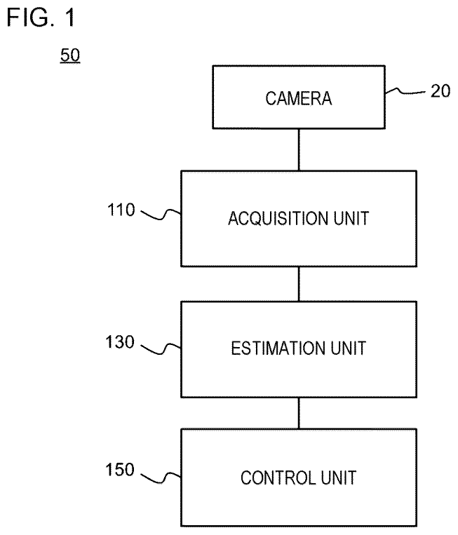

FIG. 1 is a diagram illustrating an outline of an information processing system 50 according to a first example embodiment. The information processing system 50 includes a camera 20, an acquisition unit 110, an estimation unit 130, and a control unit 150. The camera 20 is capable of capturing an image of a target. The acquisition unit 110 acquires state information indicating at least a state of the target. The estimation unit 130 generates degradation information by use of the state information. The degradation information is information relating to degradation estimated to occur in a target image acquired by capturing an image of the target with the camera 20. The control unit 150 outputs control information according to the degradation information at at least one of times before an image of the target is captured with the camera 20 and at which an image of the target is captured with the camera 20.

The information processing system 50 can estimate degradation of a target image before capturing an image of the target with the camera 20, and take a measure for acquiring a good image.

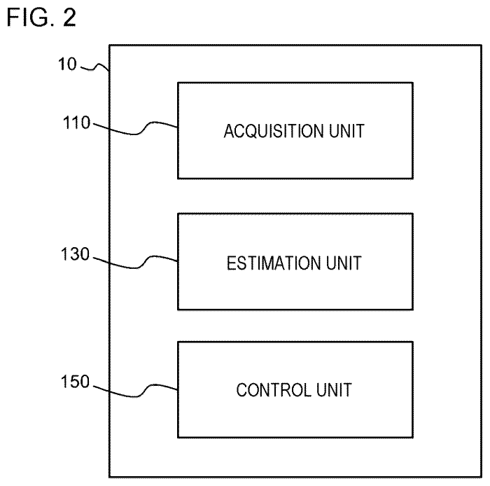

FIG. 2 is a diagram illustrating an outline of an information processing apparatus 10 according to the present example embodiment. The information processing apparatus 10 includes the acquisition unit 110, the estimation unit 130, and the control unit 150. The acquisition unit 110 acquires state information indicating at least a state of a target. The estimation unit 130 generates degradation information by use of the state information. The degradation information is information relating to degradation estimated to occur in a target image acquired by capturing an image of the target with the camera 20. The control unit 150 outputs control information according to the degradation information at at least one of times before an image of the target is captured with the camera 20 and at which an image of the target is captured with the camera 20.

The information processing apparatus 10 can estimate degradation of a target image before capturing an image of the target with the camera 20, and take a measure for acquiring a good image.

The information processing system 50 according to the present example embodiment may be configured by including the information processing apparatus 10 according to the present example embodiment.

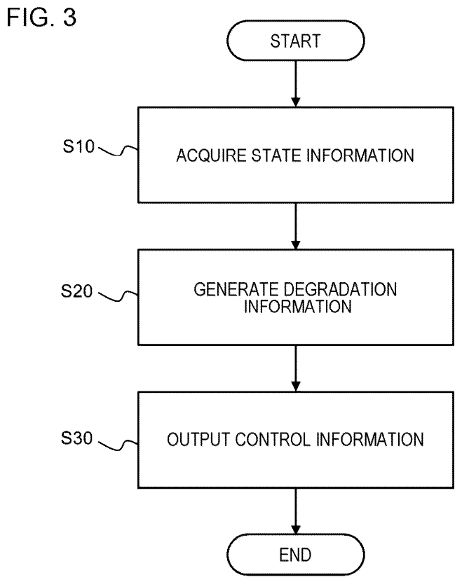

FIG. 3 is a diagram illustrating an outline of an information processing method according to the present example embodiment. The information processing method according to the present example embodiment is executed by one or more computers. The information processing method according to the present example embodiment includes steps S10, S20, and S30. In step S10, state information indicating at least a state of a target is acquired. In step S20, degradation information is generated by use of the state information. The degradation information is information relating to degradation estimated to occur in a target image acquired by capturing an image of the target with the camera 20. In step S30, control information according to the degradation information is output at at least one of times before an image of the target is captured with the camera 20 and at which an image of the target is captured with the camera 20.

The information processing method can estimate degradation of a target image before capturing an image of the target with the camera 20, and take a measure for acquiring a good image.

The information processing method according to the present example embodiment may be executed by the information processing apparatus 10 according to the present example embodiment.

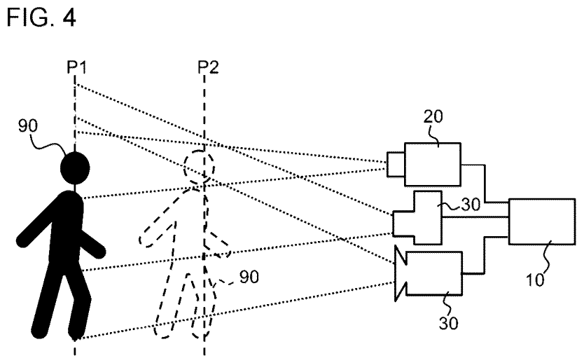

FIG. 4 is a diagram illustrating a usage environment of the information processing system 50 according to the present example embodiment. The information processing system 50 relates to, for example, a recognition system in a walk-through form. A target image captured by the camera 20 is an image used for recognition of a target 90.

In an example of FIG. 4, the target 90 moves, for example, in such a way as to approach a point P2 being a point of capturing a target image. In the information processing system 50, a state of the target 90 at a point P1 being a position farther from the camera 20 than the point P2 is measured by use of a state measurement unit 30. The estimation unit 130 of the information processing apparatus 10 estimates, based on the state of the target 90 at the point P1, degradation of the target image acquired by capturing an image of the target 90 with the camera 20 at the point P2. Then, the control unit 150 of the information processing apparatus 10 outputs, based on an estimation result, control information for suppressing degradation of the target image.

Techniques described in Patent Documents 1 to 3 cannot previously estimate degradation of an image before capture of the image, and take a measure.

In the information processing system 50, the information processing apparatus 10, and the information processing method according to the present example embodiment, the control unit 150 outputs control information according to degradation information at at least one of times before an image of a target is captured with the camera 20 and at which an image of the target is captured with the camera 20. Therefore, appropriate control for suppressing degradation is possible, and a good image can be acquired.

It is important to reduce a failure of capturing an image particularly in a system, such as a walk-through system, where there is in principle only one capture opportunity of a target image, and effort and an obstacle for re-capture are a lot. Therefore, it is particularly preferred to implement a measure for quality improvement of a target image before capture or at capture of the target image, by the information processing system 50, the information processing apparatus 10, and the information processing method according to the present example embodiment.

Note that, hereinafter, a focal position of the camera 20 is referred to as the “point P2”, and a point farther away from the camera 20 than the point P2 is referred to as the “point P1”, but the points are not limited to the example of the walk-through system illustrated in FIG. 4.

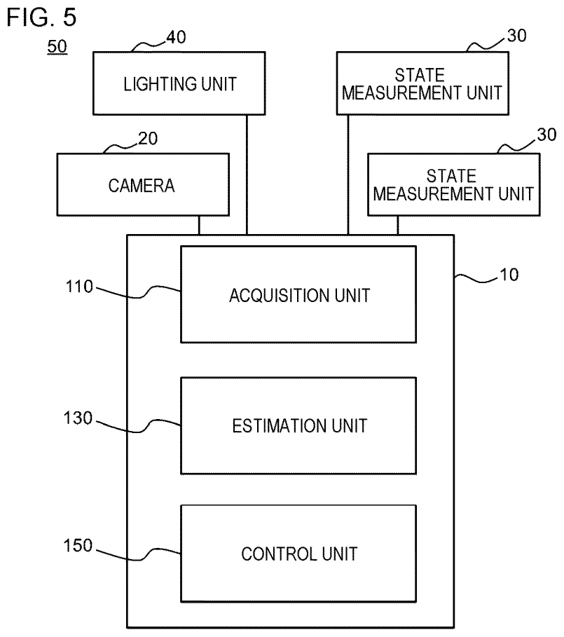

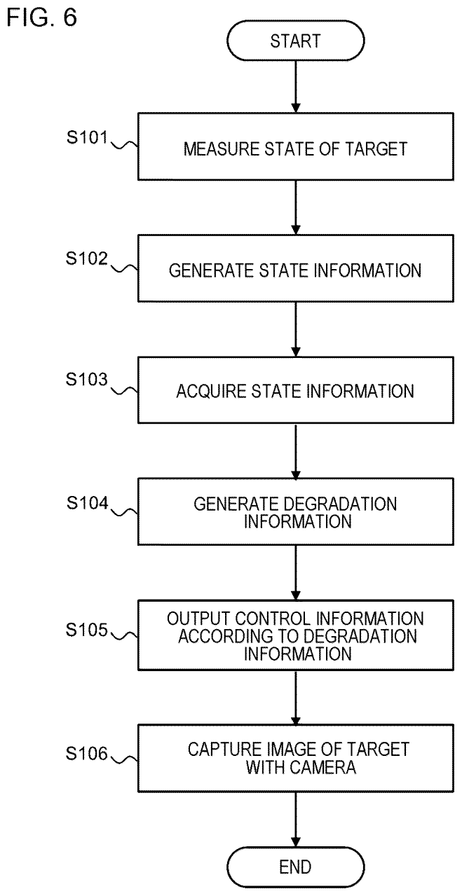

FIG. 5 is a block diagram illustrating a functional configuration of the information processing system 50 according to the present example embodiment. FIG. 6 is a flowchart illustrating a flow of processing performed by the information processing system 50 according to the present example embodiment. A detailed example of the information processing system 50, the information processing apparatus 10, and the information processing method according to the present example embodiment are described with reference to FIGS. 5 and 6.

The target 90 is, for example, a human. However, the target 90 may be a living thing other than a human, or may be an object other than a living thing. It is preferable that the target 90 moves in such a way as to approach the camera 20 before a target image is captured.

As described above, the target image captured by the camera 20 is an image used for authentication of the target 90. A focus of the camera 20 is approximately on the point P2.

The information processing system 50 is capable of performing, for example, iris recognition of the target 90. The camera 20 is, for example, an iris capture camera for capturing an iris of the target 90. The target image is an image used for iris recognition. In a case where the target image is an image used for iris recognition, the camera 20 is provided in such a way as to be capable of capturing the iris of the target 90 located at the point P2. In this case, the target image is an image including an eye. The target image may be an image including both eyes, or may be an image including only one of a right eye and a left eye. Moreover, the target image may be an image including not only an eye, but also a part around the eye.

However, recognition performed in the information processing system 50 is not limited to iris recognition. The information processing system 50 may be a system capable of performing face recognition of the target 90. The camera 20 may be a camera for capturing an image to be used for face recognition. The target image may be an image to be used for face recognition. In a case where the target image is an image to be used for face recognition, the camera 20 is provided in such a way as to be capable of capturing a face of the target 90 located at the point P2. Moreover, in a case where the target image is an image to be used for face recognition, the target image is an image including a face.

In the example of FIG. 5, the information processing system 50 further includes one or more of the state measurement units 30. State information is generated based on a measurement result by the state measurement unit 30. The state information indicates at least a state of the target 90 at a time point at which the target 90 is located at a point farther away than a focus of the camera 20. Then, the control unit 150 outputs control information at at least one of times before the target 90 reaches the focus of the camera 20 and at which the target 90 reaches the focus of the camera 20. Thereby, an image can be captured taking degradation into account without preliminarily capturing an image with the camera 20, and a good target image can be acquired.

Examples of the state measurement unit 30 include a camera, a lidar (LiDAR), and an infrared sensor. Herein, the camera is not particularly limited, and may be, for example, a depth camera, a wide-angle camera, a visible light camera, or a near-infrared camera. In a case where the state measurement unit 30 is a depth camera or a lidar, a distance from the state measurement unit 30 to the target 90, and three-dimensional information of the target 90 can be acquired. In a case where the state measurement unit 30 is a wide-angle camera, the state measurement unit 30 can capture a wider range than the camera 20, for example, the entire target 90.

In step S101, the state measurement unit 30 measures a state of the target 90 at a point farther away from the camera 20 than the point P2. Note that, in a case where the state measurement unit 30 is a camera of some type, measuring a state of the target 90 by the state measurement unit 30 includes capturing an image of the target 90 by the state measurement unit 30.

In a case where the information processing system 50 includes a plurality of the state measurement units 30, the point PI may be the same or may not be the same in the plurality of state measurement units 30. In other words, the point P1 may be set independently for each of the state measurement units 30.

The point P1 is a point where the target 90 is located before the point P2. A distance between the point P1 and the point P2 is not particularly limited, but is, for example, equal to or more than 50 cm and equal to or less than 2 m.

In step S102, state information is generated by use of a measurement result made by the state measurement unit 30. The state information includes information relating to the target 90 or a worn item of the target 90. In the present example embodiment, the state information indicates one or more of an orientation of a face, a body pose, an orientation of a gaze, a movement velocity, and presence or absence of wearing of glasses. However, the state information is not limited to the examples as long as information relating to the target 90 or a worn item of the target 90 is included. By using such state information, a degradation factor can be accurately estimated.

An orientation of a face of the target 90 can be determined by analyzing information acquired with, for example, at least one of a depth camera, a lidar, and a wide-angle camera by use of an existing technique. The state information can include, for example, angles (a left-right angle and an up-down angle) of an orientation of a face with a predetermined direction as a criterion.

A body pose of the target 90 can be determined by analyzing information acquired with, for example, at least one of a depth camera, a lidar, and a wide-angle camera by use of an existing technique. The state information can be, for example, a body pose label indicating a body pose, such as “walking”, “standing upright” or “walking with a slouch”. The body pose label can be a previously determined numerical value.

An orientation of a gaze of the target 90 can be determined by analyzing information acquired with, for example, at least one of a depth camera and a wide-angle camera by use of an existing technique. The state information can include, for example, angles (a left-right angle and an up-down angle) of an orientation of a face with a predetermined direction as a criterion.

A movement velocity of the target 90 can be determined by analyzing information acquired with, for example, at least one of a depth camera, a lidar, and a wide-angle camera by use of an existing technique. As an example, in a case where the state measurement unit 30 is an infrared sensor, passage of the target 90 at a plurality of points is sensed by a plurality of infrared sensors. Then, a velocity of the target 90 can be computed based on a distance between the plurality of points and a difference in passage timing. The state information can include, for example, information indicating an orientation and a speed of movement of the target 90.

Presence or absence of wearing of glasses of the target 90 can be determined by analyzing information acquired with, for example, at least one of a depth camera, a lidar, and a wide-angle camera by use of an existing technique. The state information can include, for example, information indicating whether the target 90 is wearing glasses.

The state information can be a vector with each of the plurality of types of information as an element.

Note that, a method of generating state information is not limited to the example described above. For example, a trained neural network may be used for generation of state information.

Processing of generating state information from a measurement result of the state measurement unit 30 may be performed by the state measurement unit 30, may be performed by the information processing apparatus 10, or may be performed by an analysis apparatus different from the information processing apparatus 10 and the state measurement unit 30. In a case where state information is generated by the analysis apparatus or the information processing apparatus 10, the analysis apparatus or the information processing apparatus 10 acquires, from one or more of the state measurement units 30, a measurement result and information necessary for generation of state information, and uses the measurement result and the information for generation of state information.

Moreover, in a case where state information includes a plurality of types of information as described above, apparatuses that generate the plurality of types of information do not all need to be the same. For example, some of the pieces of information may be generated by the state measurement unit 30, and another piece of information may be generated by the information processing apparatus 10. The information processing apparatus 10 can generate state information by combining a plurality of types of information.

In step S103, the acquisition unit 110 acquires state information. The acquisition unit 110 may acquire the state information from the state measurement unit 30, or from another analysis apparatus. Alternatively, the acquisition unit 110 may acquire state information generated by the information processing apparatus 10 by use of information acquired from one or more of the state measurement units 30 and the analysis apparatus.

In step S104, the estimation unit 130 generates degradation information by use of the state information acquired by the acquisition unit 110. The degradation information indicates, for example, one or more degradation factors to occur in the target image, and a degree of degradation for each of the one or more degradation factors. In other words, the state information indicates one or more combinations of a degradation factor and a degree of degradation. By using a degradation factor and information on the degree thereof, control for acquiring a good target image can be appropriately performed.

Herein, the one or more degradation factors include, for example, one or more of focus blur, motion blur, occlusion, and off-angle. In a case where a target image is an image including an iris, it is preferable that the one or more degradation factors include one or more of focus blur, motion blur, eyelid occlusion, lighting reflection occlusion, and off-angle. By assuming such a degradation factor as a processing target, degradation of a target image can be accurately estimated.

The degradation factor can also be said to be a type of degradation that is predicted to occur in the target image.

Focus blur is blurring of the target 90 or a predetermined part of the target 90 due to a shift in focus. The predetermined part of the target 90 is, for example, a part of a target image used for recognition. Motion blur is blurring due to a change in a relative position between the camera 20 and the target 90 or a predetermined part of the target 90. Regarding focus blur and motion blur, it can be said that a degree of degradation is higher as a degree of blurring of the target 90 or a predetermined part of the target 90 is stronger. The degree of degradation may indicate a state of a predetermined part of the target image. For example, in a case where a target image is an image including an iris, a predetermined part is the iris. Then, as a degree of blurring of the iris region in the target image is stronger, a degree of degradation may be higher.

Occlusion means that at least a part of the target 90 or a predetermined part of the target 90 is not captured in the target image. In a case where the target image is an image including an iris, eyelid occlusion means that at least a part of the iris is hidden by the eyelid. Moreover, in a case where the target image is an image including an iris, lighting reflection occlusion means that lighting reflects off a pupil, and, thereby, luminance of at least a part of the iris region of the target image heightens. In a case where there is a part (e.g., an overexposure part) being too high in luminance in an iris region, an iris pattern used for iris recognition cannot be detected.

Regarding occlusion, it can be said that a degree of degradation is higher as a proportion of the target 90 or a predetermined part of the target 90 being hidden is larger. For example, in a case where a target image is an image including an iris, it can be said that a degree of degradation is higher as a proportion of the iris being hidden is higher.

Off-angle means that an orientation of the target 90 or an orientation of a predetermined part of the target 90 deviates from an optical axis of the camera 20. For example, regarding off-angle, it can be said that a degree of degradation is higher as an angle at which the orientation of the target 90 or the orientation of the predetermined part of the target 90 deviates from the optical axis of the camera 20 is larger. For example, in a case where a target image is an image including an iris, it can be said that a degree of degradation is higher as the angle at which the orientation of the iris (e.g. an orientation of a gaze) deviates from the optical axis of the camera 20 is larger.

The degradation information includes, for example, a numerical value indicating a degradation degree, for example, for each degradation factor. The degradation information can be a vector with each of the plurality of degradation degrees as an element.

A method by which the estimation unit 130 generates degradation information is not particularly limited, but the estimation unit 130 can generate degradation information, for example, by use of a trained neural network that has trained by use of the state information and ground truth degradation information. Thereby, degradation information with high estimation accuracy can be generated.

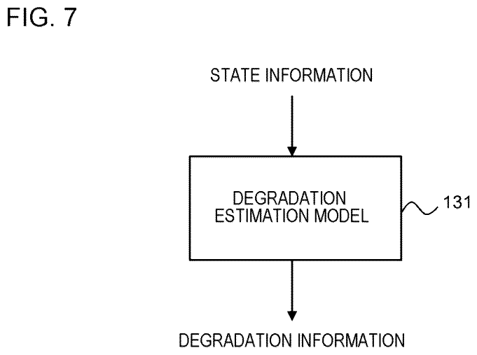

FIG. 7 is a diagram illustrating a degradation estimation model 131 used by the estimation unit 130 for generation of degradation information. Input data of the degradation estimation model 131 include state information, and output data of the degradation estimation model 131 include degradation information. The degradation estimation model 131 includes a neural network. The neural network is a trained neural network in which machine learning is previously performed by use of state information and ground truth degradation information as training data.

It is preferable that state information used in the machine learning is state information acquired in the information processing system 50 according to the present example embodiment or in a system similar to the information processing system 50 according to the present example embodiment. Moreover, it is preferable that ground truth degradation information used in the machine learning is information of degradation that has occurred in an image of the target 90 captured by the camera 20 in the information processing system 50 according to the present example embodiment or in a system similar to the information processing system 50 according to the present example embodiment. However, the ground truth degradation information is information of degradation that has occurred in an image acquired without performing any notification or control for the target 90 and the camera 20 between measurement by the state measurement unit 30 and capture by the camera 20. A type and a form of information included in the ground truth degradation information are the same as a type and a form of information in the degradation information described above.

The degradation estimation model 131 according to the present example embodiment may be a model prepared for a specific capture condition. In other words, it is preferable that a capture condition in a case of preparing a state condition and ground truth degradation information used for training of the degradation estimation model 131 is the same as a capture condition in a case of estimating degradation information by use of the degradation estimation model 131. Herein, a capture condition is, for example, one or more capture parameters of the camera 20, a state of lighting for the target 90, and a combination thereof. In the example of FIG. 5, the information processing system 50 includes a lighting unit 40, and the lighting unit 40 may be controlled by the information processing apparatus 10. The lighting unit 40 is, for example, a lighting apparatus capable of adjusting an orientation and intensity of light.

Note that, a degradation estimation model 131 may be prepared for each of a plurality of capture conditions, and may be previously held in a storage apparatus being accessible from the estimation unit 130. In this case, the estimation unit 130 selects, from a plurality of the degradation estimation models 131, and uses the degradation estimation model 131 being relevant to a capture condition at a time point at which state information is acquired. The information processing apparatus 10 can acquire, from the camera 20 and the lighting unit 40, information for determining a capture condition at a time point at which the state information is acquired.

The estimation unit 130 inputs the state information to the degradation estimation model 131. Then, the estimation unit 130 acquires degradation information output from the degradation estimation model 131.

In step S105, the control unit 150 outputs control information according to the degradation information generated by the estimation unit 130.

In the present example embodiment, the control unit 150 outputs control information for controlling a capture condition of the camera 20, based on the degradation information. Thereby, a target image with less degradation can be acquired.

The control information output by the control unit 150 is information for controlling the capture condition of the camera 20 in such a way as to suppress the degradation indicated in the degradation information. The control unit 150 outputs the control information to at least one of the camera 20 and the lighting unit 40.

In this case, the distance between the point P1 and the point P2 described above is not particularly limited, but is preferably, for example, equal to or more than 50 cm and equal to or less than 70 cm. By setting the distance between the point P1 and the point P2 to be equal to or more than 50 cm, a time of controlling a capture condition can be ensured. By setting the distance between the point P1 and the point P2 to be equal to or less than 70 cm, estimation accuracy of degradation can be improved.

An example of processing performed by the control unit 150 according to the present example embodiment is described below.

For example, in a case where a movement velocity of the target 90 is fast, degradation due to motion blur is anticipated. Then, the degradation can be reduced, for example, by shortening an exposure time of the camera 20 or by adjusting a focal position of the camera 20.

Therefore, in a case where a degree of degradation due to motion blur indicated in the degradation information is equal to or more than a predetermined criterion a, the control unit 150 outputs, to the camera 20, control information for shortening an exposure time at a time of acquiring a target image. In this instance, the control unit 150 may output control information that causes an exposure time to be shorter as a degree of degradation due to motion blur is higher.

Alternatively, in a case where a degree of degradation due to motion blur indicated in the degradation information is equal to or more than the predetermined criterion a, the control unit 150 may output, to the camera 20, control information for changing a focal distance while capturing a target image. Specifically, the control unit 150 outputs control information for causing the camera 20 to capture a target image while reducing the focal distance.

Otherwise, in a case where a degree of degradation due to focus blur indicated in degradation information is equal to or more than a predetermined criterion b, the control unit 150 outputs control information for, for example, narrowing a diaphragm of a lens of the camera 20 and widening depth of field. Alternatively, the control unit 150 outputs control information for altering a focal position of the camera 20.

In a case where a degree of degradation due to lighting reflection occlusion indicated in the degradation information is equal to or more than a predetermined criterion c, the control unit 150 outputs control information for altering at least one of the position of the camera 20, an orientation of the camera 20, a position of the lighting relative to the target 90, and an orientation of the lighting, for example, in such a way that lighting reflection does not occur on the target 90 or a predetermined part of the target 90.

In step S106, the camera 20 generates a target image by capturing an image of the target 90 located at the point P2. Note that, the camera 20 may perform capture, based on a control signal output from the control unit 150. Moreover, as described above, in a case where the control unit 150 performs control of a capture parameter by output of control information to the camera 20, the control unit 150 may output the control information at a timing at which a target image is captured. In other words, steps S105 and S106 may be simultaneous.

A degree of degradation of a target image actually acquired in step S106 is expected to be lower than a degree of degradation indicated in degradation information, i.e., an estimated degree of degradation.

A hardware configuration of the information processing apparatus 10 is described below. Each functional configuration unit (the acquisition unit 110, the estimation unit 130, and the control unit 150) of the information processing apparatus 10 may be achieved by hardware that achieves each functional configuration unit (example: a hardwired electronic circuit or the like), or may be achieved by a combination of hardware and software (example: a combination of an electronic circuit and a program that controls the electronic circuit, or the like). Hereinafter, a case where each functional configuration unit of the information processing apparatus 10 is achieved by a combination of hardware and software is further described.

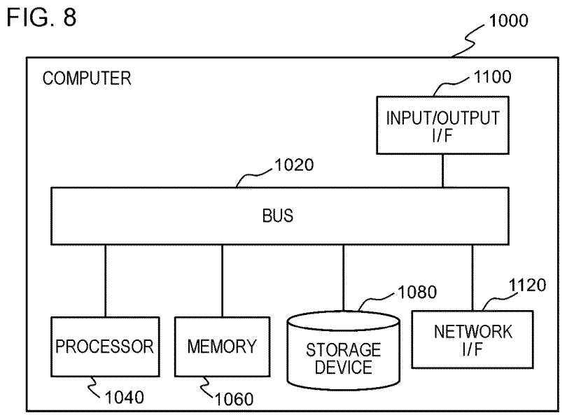

FIG. 8 is a diagram illustrating a computer 1000 for achieving the information processing apparatus 10. The computer 1000 is any computer. For example, the computer 1000 is a system on chip (SoC), a personal computer (PC), a server machine, a tablet terminal, a smartphone, or the like. The computer 1000 may be a dedicated computer designed in order to achieve the information processing apparatus 10, or may be a general-purpose computer. Moreover, the information processing apparatus 10 may be achieved by one computer 1000, or may be achieved by a combination of a plurality of the computers 1000.

The computer 1000 includes a bus 1020, a processor 1040, a memory 1060, a storage device 1080, an input/output interface 1100, and a network interface 1120. The bus 1020 is a data transmission path for the processor 1040, the memory 1060, the storage device 1080, the input/output interface 1100, and the network interface 1120 to mutually transmit and receive data. However, a method of connecting the processor 1040 and the like to each other is not limited to bus connection. The processor 1040 is a variety of processors such as a central processing unit (CPU), a graphics processing unit (GPU), or a field-programmable gate array (FPGA). The memory 1060 is a main storage apparatus achieved by use of a random access memory (RAM) and the like. The storage device 1080 is an auxiliary storage apparatus achieved by use of a hard disk, a solid state drive (SSD), a memory card, a read only memory (ROM), and the like.

The input/output interface 1100 is an interface for connecting the computer 1000 and an input/output device. For example, an input apparatus such as a keyboard, and an output apparatus such as a display are connected to the input/output interface 1100. A method in which the input/output interface 1100 is connected to the input apparatus and the output apparatus may be wireless connection, or may be wired connection.

The network interface 1120 is an interface for connecting the computer 1000 to a network. The communication network is, for example, a local area network (LAN) or a wide area network (WAN). A method in which the network interface 1120 is connected to a network may be wireless connection, or may be wired connection.

The information processing apparatus 10, the camera 20, one or more of the state measurement units 30, and the lighting unit 40 are each connected to the information processing apparatus 10 via the input/output interface 1100 or the network interface 1120, and are communicable with the information processing apparatus 10.

The storage device 1080 stores a program module that achieves each functional configuration unit of the information processing apparatus 10. The processor 1040 reads each of the program modules onto the memory 1060, executes the read program module, and thereby achieves a function being relevant to each of the program modules.

As described above, according to the present example embodiment, the control unit 150 outputs control information according to degradation information at at least one of times before an image of a target is captured with the camera 20 and at which an image of the target is captured with the camera 20. Therefore, degradation of a target image can be estimated before an image of a target is captured by the camera 20, and a measure for acquiring a good image can be taken.

### Second Example Embodiment

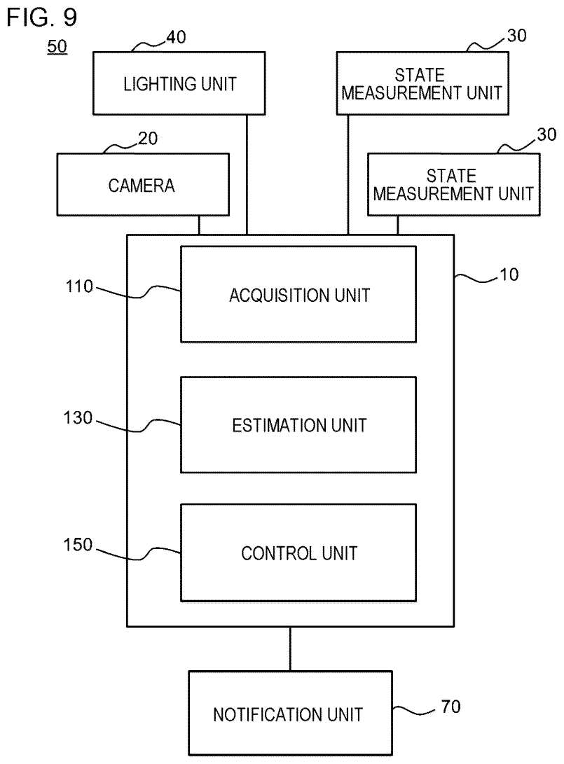

FIG. 9 is a diagram illustrating a functional configuration of an information processing system 50 according to the second example embodiment. The information processing system 50, an information processing apparatus 10, and an information processing method according to the present example embodiment are the same as the information processing system 50, the information processing apparatus 10, and the information processing method according to the first example embodiment, respectively, except for a point described below.

A control unit 150 according to the present example embodiment outputs control information for executing a notification in a case where degradation information satisfies a predetermined condition C. This can encourage the target 90 to take such an action as to avoid estimated degradation.

In an example of FIG. 9, the information processing system 50 further includes one or more notification units 70. The control unit 150 outputs, to the notification unit 70, control information for causing the notification unit 70 to execute a notification. Examples of the notification unit 70 include a display, a speaker, and a light-emitting apparatus. In a case where the notification unit 70 is a display, the notification can be, for example, a display of a message, a diagram, or the like on a display. In a case where the notification unit 70 is a speaker, the notification information can be a sound output such as a message or an alarm. In a case where the notification unit 70 is a light-emitting apparatus, the notification information can be light emission. The notification unit 70 is connected to the information processing apparatus 10 via the input/output interface 1100 or the network interface 1120.

Each of the notification units 70 is provided in such a way that the notification by the notification unit 70 can be recognized by a target 90 located between a point P1 and a point P2.

As described in the first example embodiment, the control unit 150 may output notification information instead of outputting control information for controlling a capture environment to at least one of a camera 20 and a lighting unit 40, or may output notification information in addition to outputting control information for controlling a capture environment.

An example of processing performed by the control unit 150 according to the present example embodiment is described below. Note that, in the following example, each degree of degradation being equal to or more than a predetermined criterion provided for the degree of degradation is equivalent to satisfying the predetermined condition C.

For example, in a case where a movement velocity of the target 90 is fast, degradation due to motion blur is predicted. Then, the degradation can be reduced, for example, by lowering the movement velocity of the target 90. Therefore, in a case where a degree of degradation due to motion blur indicated in degradation information is equal to or more than a predetermined criterion d, the control unit 150 outputs control information for causing the one or more notification units 70 to perform a notification encouraging the target 90 to lower the movement velocity. Thereby, for example, a message such as “Please drop walking velocity” or “Please stop once at a specified position” is displayed on a display or is issued as a sound from a speaker.

Moreover, in a case where a degree of degradation due to lighting reflection occlusion indicated in degradation information is equal to or more than a predetermined criterion e, the control unit 150 outputs control information for causing the one or more notification units 70 to perform, for example, a notification encouraging the target 90 to change an orientation of a face or a gaze. Thereby, for example, a message such as “Please look ahead” is displayed on a display, or emitted from a speaker. Alternatively, a gaze of the target 90 may be guided by a light-emitting apparatus emitting light.

In a case where a degree of degradation due to eyelid occlusion indicated in degradation information is equal to or more than the predetermined criterion e, the control unit 150 outputs control information for causing the one or more notification units 70 to perform, for example, a notification encouraging the target 90 to open an eye wide. Thereby, for example, a message such as “please open an eye wide” is displayed on a display, or emitted from a speaker.

In a case where a degree of degradation due to off-angle indicated in degradation information is equal to or more than a predetermined criterion f, the control unit 150 outputs control information for causing the one or more notification units 70 to perform, for example, a notification encouraging the target 90 to change at least one of an orientation of a face, a position, and an orientation of a gaze in such a way as to orient at least one of the orientation of the face and the gaze toward the camera 20. Thereby, for example, a message such as “Please look ahead” or “Please move a little more to right, and then orient a gaze toward this side” is displayed on a display, or emitted from a speaker. Alternatively, a gaze of the target 90 may be guided by a light-emitting apparatus emitting light.

Moreover, the control unit 150 may output control information, further based on state information. For example, in a case where state information indicates that the target 90 is wearing glasses, control information for causing the one or more notification units 70 to perform a notification encouraging the target 90 to take off glasses is output. Thereby, a message such as “Please take off the glasses” may be displayed on a display, or emitted from a speaker.

In the present example embodiment as well, the distance between the point P1 and the point P2 described above is not particularly limited, but is preferably, for example, equal to or more than 1 m and equal to or less than 2 m. By setting the distance between the point P1 and the point P2 to be equal to or more than 1 m, a time for the target 90 to change a state in response to a notification can be ensured. By setting the distance between the point P1 and the point P2 to be equal to or less than 2 m, estimation accuracy of degradation can be sufficiently ensured.

Next, an action and an effect according to the present example embodiment are described. In the present example embodiment, an action and an effect similar to those according to the first example embodiment can be acquired. In addition, the control unit 150 according to the present example embodiment outputs control information for executing a notification in a case where degradation information satisfies the predetermined condition C. Therefore, the target 90 can be encouraged to take such an action as to avoid estimated degradation.

### Third Example Embodiment

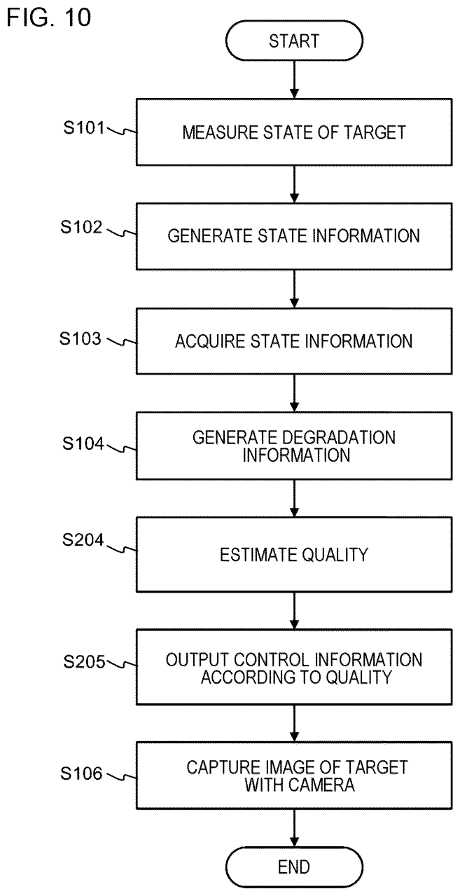

FIG. 10 is a flowchart illustrating a flow of processing executed by an information processing system 50 according to the third example embodiment. The information processing system 50, an information processing apparatus 10, and an information processing method according to the present example embodiment are the same as the information processing system 50, the information processing apparatus 10, and the information processing method according to at least one of the first and second example embodiments, respectively, except for a point described below.

A control unit 150 according to the present example embodiment estimates, by use of degradation information, quality of a target image indicating suitability as an image to be used for recognition. Then, the control unit 150 outputs control information according to the quality. Thereby, a target image suitable for recognition processing can be acquired.

In recognition processing such as iris recognition and face recognition, success or failure of recognition differs according to quality of an image used for recognition. For example, it can happen that a target 90 that is to be originally succeeded in recognition is not succeeded due to a fact that quality of an image is low. Then, quality of the image needed for recognition can differ according to performance and a characteristic of recognition equipment.

The control unit 150 according to the present example embodiment generates, for example, a quality score as quality indicating suitability as an image used in recognition.

In an example of FIG. 10, step S101 to step S104 and step S106 are as described in the first example embodiment.

In the present example embodiment, once an estimation unit 130 generates degradation information, the control unit 150 estimates quality by use of the degradation information in step S204. For example, the control unit 150 generates a quality score. As suitability as an image used in recognition is lower, a quality score of the target image becomes lower. A method by which the control unit 150 generates a quality score is not particularly limited, and may be a method by linear regression, or may be a method using a neural network. A method by which the control unit 150 generates a quality score is described in detail later.

Then, in step S205, the control unit 150 outputs control information according to the quality score. For example, only in a case where the quality score is equal to or less than a predetermined criterion g, the control unit 150 may output control information, described in the first example embodiment, for controlling a capture condition of a camera 20. Moreover, only in a case where the quality score is equal to or less than the predetermined criterion g, the control unit 150 may output control information, described in the second example embodiment, for executing a notification.

A first example and a second example of a method by which the control unit 150 generates a quality score are described below.

### First Example

In a first example, the control unit 150 computes a quality score by linear regression. In the present example, a quality score is computed by a weighted sum of degrees of degradation relating to one or more degradation factors. A weight for each degree of degradation can be previously determined, for example, as follows.

First, a plurality of images with different degradation states are prepared. Capture targets of the images may be the same as or different from each other. Then, recognition processing is performed by use of the images, and success or failure of recognition is ascertained. Moreover, the degree of degradation relating to each degradation factor is determined regarding each image. It is assumed that the degree of degradation is consistent (i.e., comparable) with a content of degradation information generated by an estimation unit 130. A weight for each degree of degradation is determined by use of a plurality of combinations of success or failure of recognition acquired in this way and one or more degrees of degradation. Then, a formula for deriving a weighted sum using the weights is defined as a formula for computing a quality score.

Note that, instead of success or failure of recognition, a recognition score indicating a likelihood of being the person in question in recognition regarding each image may be defined by another method. For example, the recognition score may be assigned to each image by a specific recognition algorithm, or may be assigned by human assessment. In this case, a weight for each degree of degradation is determined in such a way that a quality score equivalent to the recognition score is acquired by use of a plurality of combinations of the recognition score and one or more degrees of degradation. An example of a recognition algorithm is described below. In a case where recognition is iris recognition, for example, an iris feature extracted from an iris image is assumed as a feature value. Then, such a recognition algorithm as to determine whether a person is the person in question by a Hamming distance between a previously registered feature value of the person in question and a feature value extracted from an image captured by the camera 20 can be used. The recognition algorithm is not particularly limited, and various algorithms can be used. However, it is preferable that a plurality of recognition scores prepared in defining one formula for computing a quality score are prepared by use of the same algorithm.

One or more weights used in the formula may be generated by a neural network. In other words, a degree of degradation relating to one or more degradation factors and a recognition score are assumed as input data for the neural network, and the one or more weights are assumed as output data for the neural network. Then, training of the neural network is implemented in such a way that the quality score computed by use of the output weight approaches the recognition score as a ground truth. One or more weights output from the trained neural network thus acquired are assumed as weights to be used in a formula for computing a quality score.

In the present example, the control unit 150 computes a quality score by substituting each degree of degradation indicated in degradation information generated by the estimation unit 130 into a previously determined formula as described above.

### Second Example

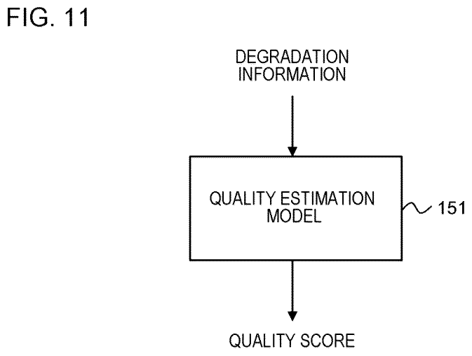

FIG. 11 is a diagram illustrating a quality estimation model 151 used by the control unit 150 for generation of a quality score. Input data of the quality estimation model 151 include degradation information, and output data of the quality estimation model 151 include a quality score. The quality estimation model 151 includes a neural network. The neural network is a trained neural network for which machine learning has been previously performed by use of a plurality of combinations of a recognition score (equivalent to a ground truth of the quality score) and one or more degrees of degradation, as described in the first example.

In the present example, the control unit 150 inputs, to the quality estimation model 151, each degree of degradation indicated in degradation information generated by the estimation unit 130. Then, the control unit 150 acquires a quality score output from the quality estimation model 151.

Next, an action and an effect according to the present example embodiment are described. In the present example embodiment, an action and an effect similar to those according to at least one of the first and second example embodiments can be acquired. In addition, according to the present example embodiment, the control unit 150 estimates, by use of degradation information, quality of a target image indicating suitability as an image to be used for recognition. Therefore, a target image suitable for recognition processing can be acquired.

### Fourth Example Embodiment

An information processing system 50, an information processing apparatus 10, and an information processing method according to a fourth example embodiment are the same as the information processing system 50, the information processing apparatus 10, and the information processing method according to at least one of the first to third example embodiments, respectively, except for a point described below.

The control unit 150 according to the present example embodiment cancels image capture of a target 90 by a camera 20, in a case where degradation information satisfies a predetermined condition D. Thereby, unnecessary processing can be reduced in a case where a possibility that a good target image can be acquired is low.

The condition D is a condition indicating that a possibility that a good target image can be acquired is low. The condition D may be a condition on degradation information itself, or may be a condition relating to quality (a quality score) acquired from degradation information as in the third example embodiment. In that case, in a case where it is estimated that a target image cannot satisfy quality needed for recognition, image capture of the target 90 by the camera 20 is canceled.

As an example, the condition D is that, among one or more degrees of degradation indicated in degradation information, a predetermined number or more of degrees of degradation are equal to or more than a predetermined criterion set for each degree of degradation. As another example, the condition D is that a quality score acquired based on degradation information is equal to or less than a predetermined score. However, the condition D is not limited to the examples.

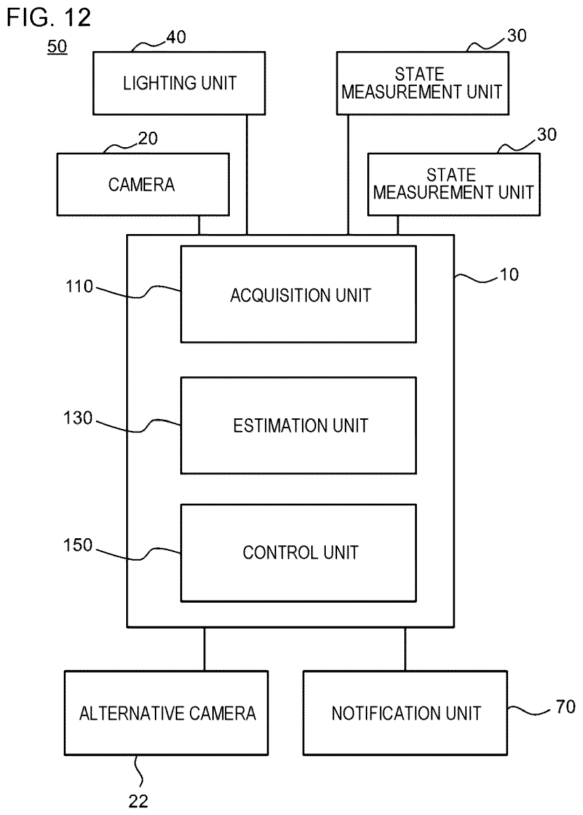

FIG. 12 is a block diagram illustrating a functional configuration of the information processing system 50 according to the present example embodiment. The information processing system 50 according to the present example embodiment includes one or more notification units 70, similar to the information processing system 50 according to the second example embodiment. The control unit 150 according to the present example embodiment cancels image capture of the target 90 by the camera 20, and outputs control information for executing a notification. The control unit 150 according to the present example embodiment does not need to output control information for controlling a capture condition of the camera 20.

In a case where degradation information satisfies the predetermined condition D, the control unit 150 outputs control information for causing the one or more notification units 70 to perform a notification, for example, encouraging the target 90 to return once and re-perform movement. Thereby, for example, a message such as “Please return a little and walk again” may be displayed on a display, or emitted from a speaker.

Due to such a notification, it is expected that the target 90 re-performs movement again. Accordingly, the information processing system 50 can again perform measurement at a point P1, generation of state information, generation of degradation information, and the like. According to the present example, since the re-performance can be implemented without capturing an image of the target 90 with the camera 20, a good target image can be acquired in a short time as compared with a case where re-performance is encouraged after an image of the target 90 is captured with the camera 20.

Moreover, in an example of FIG. 12, the information processing system 50 according to the present example embodiment further includes an alternative camera 22. The alternative camera 22 is a camera provided separately from the camera 20, and is a camera for capturing an image of the target 90 instead of the camera 20 and generating a target image.

A hardware configuration of a computer that achieves the information processing apparatus 10 according to the present example embodiment is represented by, for example, FIG. 8, similar to the information processing apparatus 10 according to the first example embodiment. The alternative camera 22 is connected to the information processing apparatus 10 via an input/output interface 1100 or a network interface 1120.

In a case where the degradation information satisfies the predetermined condition D, the control unit 150 outputs control information for causing the one or more notification units 70 to perform, for example, a notification encouraging the target 90 to stop in a capture region of the alternative camera 22. Thereby, for example, a message such as “Please stop in front of a camera on a right side” is displayed on a display, or emitted from a speaker.

Due to such a notification, it is expected that the target 90 stops at a position where the target 90 is capturable well with the alternative camera 22. Accordingly, the information processing system 50 captures an image of the target 90 with the alternative camera 22, and a good target image can be acquired. According to the present example, since capture by the alternative camera 22 can be implemented without capturing an image of the target 90 with the camera 20, a good target image can be acquired in a short time as compared with a case where re-capture is encouraged after the target 90 is captured with the camera 20.

Next, an action and an effect according to the present example embodiment are described. In the present example embodiment, an action and an effect similar to those according to at least one of the first and second example embodiments can be acquired. In addition, the control unit 150 according to the present example embodiment cancels image capture of the target 90 by the camera 20 in a case where degradation information satisfies the predetermined condition D. Therefore, unnecessary processing can be reduced in a case where a possibility that a good target image can be acquired is low.

### Fifth Example Embodiment

An information processing system 50, an information processing apparatus 10, and an information processing method according to a fifth example embodiment are the same as the information processing system 50, the information processing apparatus 10, and the information processing method according to at least any of the first to fourth example embodiments, respectively, except for a point described below.

In the information processing system 50 according to the present example embodiment, state information further indicates a capture condition of a camera 20. The capture condition includes a capture parameter of the camera 20 and an environmental condition. For example, the state information indicates one or more of an exposure time of the camera 20, a state of lighting for the target 90, a focal position of the camera 20, aperture size of a lens of the camera 20, and brightness of a capture region of the camera 20. By estimating degradation of a target image by use of the state information further indicating the capture condition of the camera 20, a degradation factor and a degree of degradation can be accurately estimated.

In the first example embodiment, a degradation estimation model 131 is a model that has trained premising a specific capture condition. On the other hand, in such a case that a capture condition changes due to an influence of external light and the like, an actual capture condition may not necessarily match a capture condition premised in the degradation estimation model 131. Moreover, in such a capture environment that brightness of a capture region changes, a capture parameter of the camera 20 may not be fixed, and may be automatically adjusted according to brightness or the like of the capture region.

By generating degradation information by use of state information including a capture condition, degradation can be accurately estimated even in a case where the capture condition changes. Moreover, there is no need to previously prepare the degradation estimation model 131 for each of diverse capture conditions.

As described above, in the present example embodiment, state information indicates, for example, one or more of an exposure time of the camera 20, a state of lighting for the target 90, a focal position of the camera 20, aperture size of a lens of the camera 20, and brightness of a capture region of the camera 20.

An example of a state of lighting for the target 90 includes at least one of an orientation and intensity of the lighting by the lighting unit 40. An example of a focal position of the camera 20 includes at least one of a focal distance and a coordinate of a focal position.

The information processing apparatus 10 can acquire, from the camera 20, information indicating an exposure time of the camera 20, a focal position of the camera 20, and aperture size of a lens of the camera 20. The information processing apparatus 10 can acquire, from the lighting unit 40, information indicating a state of lighting for the target 90. Moreover, the information processing apparatus 10 can acquire information indicating brightness of a capture region of the camera 20, from an illuminance sensor or the like provided in the image capturing region.

In addition to information indicating a state of the target 90 described in the first example embodiment, the information processing apparatus 10 acquires one or more pieces of information indicating the capture condition of the camera 20 as described above. Then, the information processing apparatus 10 generates state information including both the information indicating a state of the target 90 and information indicating a capture condition of the camera 20. The state information can be a vector with each of a plurality of types of information (an orientation of a face, a body pose, an exposure time of the camera 20, a focal position of the camera 20, and the like) as an element. Then, the acquisition unit 110 acquires the generated state information.

In the present example embodiment, the estimation unit 130 can generate degradation information by use of the degradation estimation model 131. However, in the present example embodiment, since degradation information includes information indicating a capture condition of the camera 20, it can be said that an input of the degradation estimation model 131 also includes a condition indicating the capture condition of the camera 20.

The degradation estimation model 131 according to the present example embodiment can train similar to the degradation estimation model 131 according to the first example embodiment. However, state information used in machine learning of the degradation estimation model 131 according to the present example embodiment includes information indicating a capture condition of the camera 20. The information indicating the capture condition is information indicating a capture condition in a case where an image to be a source of ground truth degradation information is captured.

The degradation estimation model 131 according to the present example embodiment is a model being utilizable regardless of a capture condition.

The estimation unit 130 according to the present example embodiment generates degradation information, by use of state information including information indicating a capture condition, in a way similar to that described in the first example embodiment. Then, the control unit 150 according to the present example embodiment outputs control information, similar to the control unit 150 according to at least one of the first to fourth example embodiments.

Next, an action and an effect according to the present example embodiment are described. In the present example embodiment, an action and an effect similar to those according to at least one of the first to fourth example embodiments can be acquired. In addition, in the information processing system 50 according to the present example embodiment, state information further indicates a capture condition of the camera 20. Therefore, a degradation factor and a degree of degradation can be accurately estimated.

### Sixth Example Embodiment

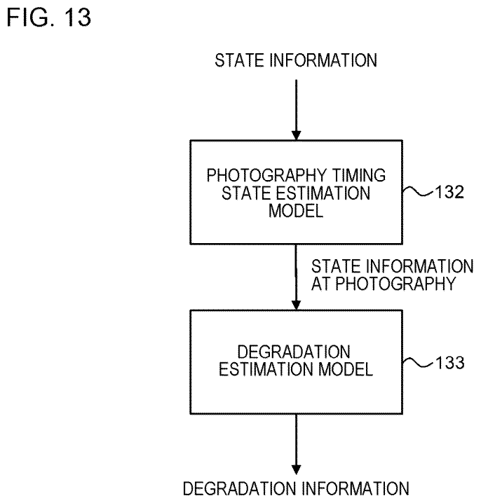

FIG. 13 is a diagram for describing a method in which an estimation unit 130 according to a sixth example embodiment generates degradation information. An information processing system 50, an information processing apparatus 10, and an information processing method according to the present example embodiment are the same as the information processing system 50, the information processing apparatus 10, and the information processing method according to at least one of the first to fifth example embodiments, respectively, except for a point described below.

The estimation unit 130 according to the present example embodiment generates, by use of state information, state information at capture indicating a result of estimating a state of a target 90 at a time point at which the target 90 reaches focus of a camera 20. Then, the estimation unit 130 generates degradation information by use of the state information at capture. In this way, the estimation unit 130 according to the present example embodiment executes estimation of degradation separately in a first stage in which a state at capture is estimated based on a state at a point P1, and a second stage in which degradation of a target image is estimated based on a state at capture. Thereby, the information processing system 50 can be applied to a change in a state between the point P1 and the point P2 due to a change in a usage environment of the information processing system 50, without altering processing in the second stage (e.g., an estimation model).

A configuration of the state information at capture is the same as a configuration of state information. In other words, the state information at capture indicates at least a state of a target. The state information at capture may further indicate a capture condition of the camera 20. The state information at capture can be a vector with each of a plurality of types of information as an element.

The estimation unit 130 according to the present example embodiment generates degradation information from state information by use of, for example, a capture timing state estimation model 132 and a degradation estimation model 133. Each of the capture timing state estimation model 132 and the degradation estimation model 133 is a trained model including a neural network. The capture timing state estimation model 132 is a model for estimating a state at capture, based on a state at the point P1. The degradation estimation model 133 is a model for estimating degradation of a target image, based on a state at capture.

Input data of the capture timing state estimation model 132 include state information, and output data of the capture timing state estimation model 132 include state information at capture. The capture timing state estimation model 132 can be previously prepared by performing machine learning using state information and ground truth state information as training data. The ground truth state information is information acquired by measuring a state (at the point P2) at capture. In other words, measurement of a state at the point P2 and generation of ground truth state information can be performed by the same method as that by which the information processing system 50 generates state information at the point P1. State information used for machine learning of the capture timing state estimation model 132 may be the same as state information used for machine learning of the degradation estimation model 131. It is preferable that a configuration of ground truth state information is the same as state information.

Input data of the degradation estimation model 133 include state information at capture, and output data of the degradation estimation model 133 include degradation information. The degradation estimation model 133 can be previously prepared by performing machine learning using, as training data, the ground truth state information described above and the ground truth degradation information described above.

The estimation unit 130 according to the present example embodiment inputs a state acquired by an acquisition unit 110 to the capture timing state estimation model 132, and acquires state information at capture output from the capture timing state estimation model 132. Further, the estimation unit 130 inputs the state information at capture to the degradation estimation model 133, and acquires degradation information output from the degradation estimation model 133. Then, a control unit 150 according to the present example embodiment outputs control information, similar to the control unit 150 according to at least one of the first to fourth example embodiments.

In the present example embodiment, state information may or may not include information indicating a capture condition of the camera 20. In a case where the state information includes information indicating a capture condition of the camera 20, state information at capture and ground truth state information also include information indicating a capture condition of the camera 20.

In a case where state information does not include information indicating a capture condition of the camera 20, the capture timing state estimation model 132 and the degradation estimation model 133 may be prepared regarding each of a plurality of capture conditions. The capture timing state estimation model 132 and the degradation estimation model 133 regarding each of the plurality of capture conditions are previously held in a storage apparatus accessible from the estimation unit 130. Then, similar to the first example embodiment, the estimation unit 130 uses the capture timing state estimation model 132 and the degradation estimation model 133 that are relevant to a capture condition at a time point at which state information is acquired.

Instead of using the capture timing state estimation model 132, the estimation unit 130 may generate state information at capture, based on a predetermined rule. For example, the estimation unit 130 can generate state information at capture from state information, based on the following rule. Hereinafter, a time point at which a state measurement unit 30 measures a state of the target 90 is referred to as a time point T1, and a time point at which the target 90 reaches a focus of the camera 20 is referred to as a time point T2.

The estimation unit 130 estimates a body pose and a movement velocity at the time point T2, for example, based on a body pose and a movement velocity of the target 90 at the time point T1. For the estimation, for example, a walking model described in a literature “Nisoku Hokou no Sougou Kaiseki Moderu to Shimyureeshon (Comprehensive Analysis Model and Simulation of Bipedal Walking)” by Nobutoshi Yamazaki (Biomechanism, Vol. 3, 1975, pp. 261 to 269) can be used. Moreover, in a case where a notification encouraging deceleration is constantly performed, the estimation unit 130 may compute a lower velocity at the time point T2. A lowering amount of a velocity can be previously determined based on a result of an advance research or experiment (e.g., an average of a plurality of the targets 90).

For example, the estimation unit 130 assumes an orientation of a face and an orientation of a gaze of the target 90 at the time point T1 as estimation results of an orientation of the face and an orientation of a gaze of the target 90 at the time point T2, respectively. However, in a case where guidance relating to an orientation of a face or a gaze is always performed, the estimation unit 130 may assume a direction toward a guidance destination as an estimation result of an orientation of the face and an orientation of a gaze of the target 90 at the time point T2.

For example, the estimation unit 130 assumes presence or absence of wearing of glasses at the time point T1 as an estimation result of presence or absence of wearing of glasses at the time point T2. However, in a case where guidance of causing the target 90 to take off glasses is constantly performed, the estimation unit 130 may estimate that the target 90 is not wearing glasses at the time point T2.

The estimation unit 130 can generate, based on the rules, state information at capture from state information. Then, degradation information can be acquired by inputting the generated state information at capture to the degradation estimation model 133.

Next, an action and an effect according to the present example embodiment are described. In the present example embodiment, an action and an effect similar to those according to at least one of the first to fifth example embodiments can be acquired. In addition, the estimation unit 130 according to the present example embodiment generates, by use of state information, state information at capture indicating a result of estimating a state of the target 90 at a time point at which the target 90 reaches the focus of the camera 20. Then, the estimation unit 130 generates degradation information by use of the state information at capture. Therefore, a response can be made to a change in state between the point P1 and the point P2 with a minor alteration.

### Seventh Example Embodiment

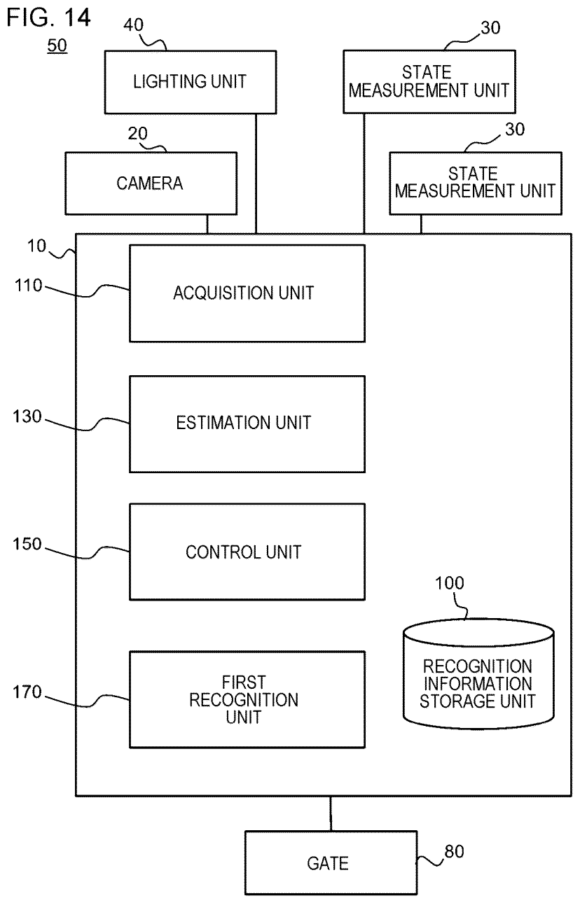

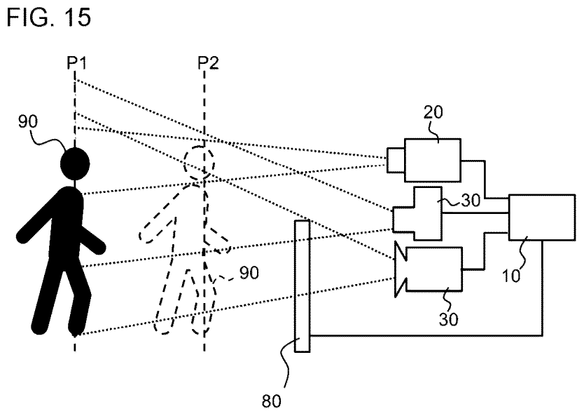

FIG. 14 is a block diagram illustrating a functional configuration of an information processing system 50 according to a seventh example embodiment. FIG. 15 is a diagram illustrating a usage environment of the information processing system 50 according to the present example embodiment. The information processing system 50, an information processing apparatus 10, and an information processing method according to the present example embodiment are the same as the information processing system 50, the information processing apparatus 10, and the information processing method according to at least one of the first to sixth example embodiments, respectively, except for a point described below.

The information processing apparatus 10 according to the present example embodiment further includes a first recognition unit 170. In other words, the information processing system 50 according to the present example embodiment further includes the first recognition unit 170. The first recognition unit 170 performs recognition by use of a target image of a target 90 generated by the camera 20. Recognition processing performed by the first recognition unit 170 is, for example, processing of iris recognition or face recognition. However, the recognition processing performed by the first recognition unit 170 is not limited to the examples, and can be any recognition processing.

The first recognition unit 170 can perform recognition processing by use of an existing method. For example, the first recognition unit 170 detects a predetermined region in a target image, extracts a feature of the detected region, and thereby acquires feature information. In a case where the first recognition unit 170 performs iris recognition processing, the predetermined region is a region corresponding to an iris. In a case where the first recognition unit 170 performs face recognition processing, the predetermined region is a region corresponding to the face.

A recognition information storage unit 100 previously holds a plurality of pieces of recognition information in which identification information and feature information are associated with each other. The identification information is information for individually identifying a plurality of the targets 90. In a case where the target 90 is a person, the identification information is, for example, personal identification information.

The recognition information storage unit 100 may be included in the information processing apparatus 10, or may be provided outside the information processing apparatus 10. However, the first recognition unit 170 is capable of accessing the recognition information storage unit 100. The first recognition unit 170 collates feature information acquired from a target image with each piece of feature information held in the recognition information storage unit 100. Then, the first recognition unit 170 determines feature information with the highest matching degree with the feature information acquired from the target image from among a plurality of pieces of feature information held in the recognition information storage unit 100. Then, the first recognition unit 170 determines identification information associated with the determined feature information as identification information of the target 90 captured by the camera 20.

The first recognition unit 170 outputs identification information of the determined target 90. The first recognition unit 170 may display the identification information of the target 90 on, for example, a display, or may transmit the identification information of the target 90 to another apparatus.

Note that, in a case where feature information in which a matching degree with feature information acquired from the target image exceeds a predetermined criterion is not present among a plurality of pieces of feature information held in the recognition information storage unit 100, the first recognition unit 170 may output information indicating that recognition has not been succeeded.

Moreover, the first recognition unit 170 may control passage of the target 90 according to identification information of the target 90. In examples of FIGS. 14 and 15, the information processing system 50 further includes a gate 80. The recognition information held in the recognition information storage unit 100 includes information associated with identification information and indicating permission/non-permission of passage.

Once the first recognition unit 170 determines identification information of the target 90, the first recognition unit 170 reads information associated with the identification information and indicating permission/non-permission of passage. In a case where information indicating that passage is possible is associated with the identification information, the first recognition unit 170 brings the gate 80 into a state where the target 90 is capable of passing. On the other hand, in a case where information indicating that passage is possible is not associated with the identification information, the first recognition unit 170 does not bring the gate 80 into a state where the target 90 is capable of passing. The first recognition unit 170 does not bring the gate 80 into a state where the target 90 is capable of passing in a case where feature information in which a matching degree with feature information acquired from the target image exceeds a predetermined criterion is not present among a plurality of pieces of feature information held in the recognition information storage unit 100 as well. In this way, the information processing system 50 can control passage of the target 90.

A hardware configuration of a computer that achieves the information processing apparatus 10 according to the present example embodiment is represented by, for example, FIG. 8, similar to the information processing apparatus 10 according to the first example embodiment. However, a storage device 1080 of a computer 1000 that achieves the information processing apparatus 10 according to the present example embodiment further stores a program module that achieves a function of the first recognition unit 170 according to the present example embodiment.

Moreover, in a case where the recognition information storage unit 100 is provided inside the information processing apparatus 10, for example, the recognition information storage unit 100 is achieved by use of a storage device 1080. The gate 80 is connected to the information processing apparatus 10 via an input/output interface 1100 or a network interface 1120.

Next, an action and an effect according to the present example embodiment are described. In the present example embodiment, an action and an effect similar to those according to at least one of the first to sixth example embodiments can be acquired. In addition, the information processing apparatus 10 according to the present example embodiment further includes the first recognition unit 170. Therefore, recognition using a target image can be performed.

### Eighth Example Embodiment

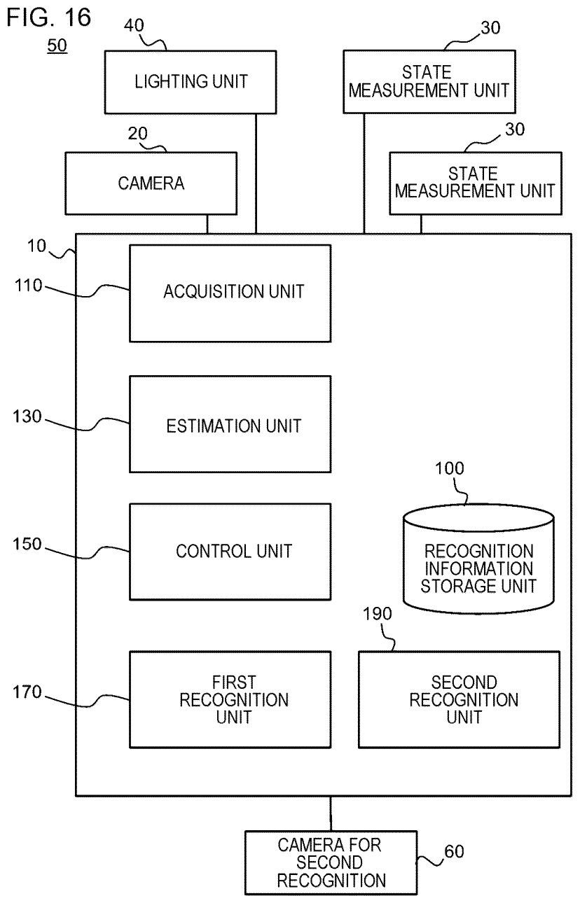

FIG. 16 is a block diagram illustrating a functional configuration of an information processing system 50 according to an eighth example embodiment. The information processing system 50, an information processing apparatus 10, and an information processing method according to the present example embodiment are the same as the information processing system 50, the information processing apparatus 10, and the information processing method according to at least one of the first to the seventh example embodiments, respectively, except for a point described below.

The information processing system 50 according to the present example embodiment includes a first recognition unit 170. The first recognition unit 170 performs recognition by use of a target image. The information processing system 50 according to the present example embodiment further includes a second recognition unit 190. The second recognition unit 190 performs recognition by use of information different from the target image. Then, in a case where quality based on degradation information satisfies a predetermined condition A, a control unit 150 raises an importance degree of recognition by the second recognition unit 190. Thereby, a possibility that recognition can be succeeded by the second recognition unit 190 can be heightened even in a case where a good target image cannot be acquired by a camera 20.

In an example of FIG. 16, the first recognition unit 170 according to the present example embodiment performs, for example, processing of iris recognition by use of a target image acquired with the camera 20. On the other hand, the second recognition unit 190 performs, for example, face recognition by use of an image acquired with a camera for second recognition 60 different from the camera 20. The camera 20 and the camera for second recognition 60 are controlled independently, and an image of the target 90 can be acquired. Recognition processing performed by each of the first recognition unit 170 and the second recognition unit 190 is as described in relation to the first recognition unit 170 in the seventh example embodiment.

The information processing system 50 can acquire both a recognition result made by the first recognition unit 170 and a recognition result made by the second recognition unit 190. The information processing system 50 may output both of pieces of the recognition results, or may output only a recognition result with a higher reliability degree of the recognition results. For example, of the two recognition results, a recognition result with a higher recognition score may be output as a recognition result with a higher reliability degree. Examples of a recognition score include a matching degree with feature information in recognition information described above, and a score based on a Hamming distance described above. Otherwise, the information processing system 50 may determine and output a final recognition result, based on a result acquired by integrating the two recognition results and a recognition score, or based on the recognition score. For example, a recognition result may be determined and output based on one of a sum, a product, and an average of the two recognition scores.

As described in the third example embodiment, the control unit 150 according to the present example embodiment estimates, by use of degradation information, a quality score of a target image indicating suitability as an image to be used for recognition.

Then, in a case where a quality score satisfies a predetermined condition A (e.g., in a case where a quality score is equal to or less than a predetermined score), the control unit 150 raises an importance degree of recognition by the second recognition unit 190. In other words, the control unit 150 controls the camera for second recognition 60 in such a way as to heighten quality of an image of the target 90 acquired with the camera for second recognition 60. For example, the control unit 150 outputs control information for raising resolution of the camera for second recognition 60 at a time of capturing an image of the target 90. Alternatively, the control unit 150 outputs control information for causing the camera for second recognition 60 to capture an image of the target 90 at a timing at which an image capturing a predetermined part of the target 90 larger can be acquired with the camera for second recognition 60. Herein, the predetermined part of the target 90 is a part that the second recognition unit 190 uses for recognition, and is, for example, a face.

Thereby, in a case where it is estimated that a high-quality target image cannot be acquired by the camera 20, quality of an image acquired by the camera for second recognition 60 can be heightened. Therefore, recognition performance is improved.

On the other hand, in a case where quality does not satisfy the predetermined condition A, the control unit 150 does not raise an importance degree of recognition by the second recognition unit 190.

A hardware configuration of a computer that achieves the information processing apparatus 10 according to the present example embodiment is represented by, for example, FIG. 8, similar to the information processing apparatus 10 according to the first example embodiment. However, a storage device 1080 of a computer 1000 that achieves the information processing apparatus 10 according to the present example embodiment further stores a program module that achieves functions of the first recognition unit 170 and the second recognition unit 190 according to the present example embodiment.

Moreover, in a case where the recognition information storage unit 100 is provided inside the information processing apparatus 10, for example, the recognition information storage unit 100 is achieved by use of a storage device 1080. The camera for second recognition 60 is connected to the information processing apparatus 10 via an input/output interface 1100 or a network interface 1120.

Next, an action and an effect according to the present example embodiment are described. In the present example embodiment, an action and an effect similar to those according to the first example embodiment can be acquired. In addition, the control unit 150 according to the present example embodiment raises an importance degree of recognition by the second recognition unit 190 in a case where quality based on degradation information satisfies the predetermined condition A. Therefore, in a case where it is estimated that a good target image cannot be acquired with the camera 20, a possibility that recognition can be succeeded by the second recognition unit 190 can be heightened.

### Modified Example

The present modified example is a modified example of the eighth example embodiment. An information processing system 50, an information processing apparatus 10, and an information processing method according to the present modified example are the same as the information processing system 50, the information processing apparatus 10, and the information processing method according to the eighth example embodiment, respectively, except for a point described below.

The information processing system 50 according to the present example embodiment includes a first recognition unit 170 and a second recognition unit 190, similar to the information processing system 50 according to the eighth example embodiment. Then, the control unit 150 according to the present example embodiment raises an importance degree of recognition by the second recognition unit 190 in a case where degradation information satisfies a predetermined condition B.

The control unit 150 according to the present example embodiment may not estimate quality. The condition B is a condition for degradation information itself. The condition B is, for example, that, among one or more degrees of degradation indicated in degradation information, a predetermined number or more of degrees of degradation are equal to or more than a predetermined criterion set for each degree of degradation.

In a case where degradation information satisfies the predetermined condition B, the control unit 150 raises an importance degree of recognition by the second recognition unit 190. An example of a method by which the control unit 150 raises an importance degree of recognition by the second recognition unit 190 is as described in the eighth example embodiment.

In the present modified example as well, an action and an effect similar to those according to the eighth example embodiment can be acquired. In other words, in a case where it is estimated that a good target image cannot be acquired with a camera 20, a possibility that recognition is succeeded by the second recognition unit 190 can be heightened.

The example embodiments and the modified example of this disclosure have been described above with reference to the drawings, but are exemplifications of the present invention, and various configurations other than those described above can be adopted.

Moreover, although a plurality of steps (pieces of processing) are described in order in a plurality of flowcharts used in the above description, an execution order of steps executed in each of the example embodiments and the modified example is not limited to the described order. In each of the example embodiments and the modified example, an order of illustrated steps can be changed to an extent that causes no problem in terms of content. Moreover, each of the example embodiments and the modified example described above can be combined to an extent that content does not contradict.

Some or all of the above-described example embodiments can also be described as, but are not limited to, the following supplementary notes.
1-1. An information processing system including:
   a camera being capable of capturing an image of a target;
   an acquisition unit that acquires state information indicating at least a state of the target;
   an estimation unit that generates, by use of the state information, degradation information relating to degradation estimated to occur in a target image acquired by capturing an image of the target with the camera; and
   a control unit that outputs control information according to the degradation information at least one of times before an image of the target is captured with the camera and at which an image of the target is captured with the camera.
1-2. The information processing system according to supplementary note 1-1, in which
   the state information indicates at least a state of the target at a time point at which the target is located at a point farther away than a focus of the camera, and
   the control unit outputs the control information at least one of times before the target reaches the focus of the camera and at which the target reaches the focus of the camera.
1-3. The information processing system according to supplementary note 1-2, in which
   the estimation unit
      generates, by use of the state information, state information at capture indicating a result of estimating a state of the target at a time point at which the target reaches the focus of the camera, and
      generates the degradation information by use of the state information at capture.
1-4. The information processing system according to any one of supplementary notes 1-1 to 1-3, in which
   the degradation information indicates one or more degradation factors to occur in the target image and a degree of degradation of each of the one or more degradation factors.
1-5. The information processing system according to supplementary note 1-4, in which
   the target image is an image including an iris, and
   the one or more degradation factors include one or more of focus blur, motion blur, eyelid occlusion, lighting reflection occlusion, and off-angle.
1-6. The information processing system according to any one of supplementary notes 1-1 to 1-5, in which
   the control unit
      estimates, by use of the degradation information, quality of the target image, the quality indicating suitability as an image to be used for recognition, and
      outputs the control information according to the quality.
1-7. The information processing system according to supplementary note 1-6, further including:
   a first recognition unit that performs recognition by use of the target image; and
   a second recognition unit that performs recognition by use of information different from the target image, in which
   the control unit raises an importance degree of recognition by the second recognition unit in a case where the quality satisfies a predetermined condition A.
1-8. The information processing system according to any one of supplementary notes 1-1 to 1-7, further including:
   a first recognition unit that performs recognition by use of the target image; and
   a second recognition unit that performs recognition by use of information different from the target image, in which
   the control unit raises an importance degree of recognition by the second recognition unit in a case where the degradation information satisfies a predetermined condition B.
1-9. The information processing system according to any one of supplementary notes 1-1 to 1-8, in which
   the state information indicates one or more of an orientation of a face, a body pose, an orientation of a gaze, a movement velocity, and presence or absence of wearing of glasses.
1-10. The information processing system according to any one of supplementary notes 1-1 to 1-9, in which
   the state information further indicates a capture condition of the camera.
1-11. The information processing system according to supplementary note 1-10, in which
   the state information indicates one or more of an exposure time of the camera, a state of lighting for the target, a focal position of the camera, aperture size of a lens of the camera, and brightness of a capture region of the camera.
1-12. The information processing system according to any one of supplementary notes 1-1 to 1-11, in which
   the estimation unit generates the degradation information by use of a trained neural network that has trained by use of the state information and ground truth degradation information.
1-13. The information processing system according to any one of supplementary notes 1-1 to 1-12, in which
   the control unit outputs the control information for executing a notification in a case where the degradation information satisfies a predetermined condition C.
1-14. The information processing system according to any one of supplementary notes 1-1 to 1-13, in which
   the control unit cancels image capture of the target by the camera in a case where the degradation information satisfies a predetermined condition D.
1-15. The information processing system according to any one of supplementary notes 1-1 to 1-14, in which
   the control unit outputs the control information for controlling a capture condition of the camera, based on the degradation information.
2-1. An information processing apparatus including:
   an acquisition unit that acquires state information indicating at least a state of a target;
   an estimation unit that generates, by use of the state information, degradation information relating to degradation estimated to occur in a target image acquired by capturing an image of the target with a camera; and
   a control unit that outputs control information according to the degradation information at least one of times before an image of the target is captured with the camera and at which an image of the target is captured with the camera.
2-2. The information processing apparatus according to supplementary note 2-1, in which
   the state information indicates at least a state of the target at a time point at which the target is located at a point farther away than a focus of the camera, and
   the control unit outputs the control information at least one of times before the target reaches the focus of the camera and at which the target reaches the focus of the camera.
2-3. The information processing apparatus according to supplementary note 2-2, in which
   the estimation unit
      generates, by use of the state information, state information at capture indicating a result of estimating a state of the target at a time point at which the target reaches the focus of the camera, and
      generates the degradation information by use of the state information at capture.
2-4. The information processing apparatus according to any one of supplementary notes 2-1 to 2-3, in which
   the degradation information indicates one or more degradation factors to occur in the target image and a degree of degradation of each of the one or more degradation factors.
2-5. The information processing apparatus according to supplementary note 2-4, in which
   the target image is an image including an iris, and
   the one or more degradation factors include one or more of focus blur, motion blur, eyelid occlusion, lighting reflection occlusion, and off-angle.
2-6. The information processing apparatus according to any one of supplementary notes 2-1 to 2-5, in which
   the control unit
      estimates, by use of the degradation information, quality of the target image, the quality indicating suitability as an image to be used for recognition, and
      outputs the control information according to the quality.
2-7 The information processing apparatus according to supplementary note 2-6, further including:
   a first recognition unit that performs recognition by use of the target image; and
   a second recognition unit that performs recognition by use of information different from the target image, in which
   the control unit raises an importance degree of recognition by the second recognition unit in a case where the quality satisfies a predetermined condition A.
2-8. The information processing apparatus according to any one of supplementary notes 2-1 to 2-7, further including:
   a first recognition unit that performs recognition by use of the target image; and
   a second recognition unit that performs recognition by use of information different from the target image, in which
   the control unit raises an importance degree of recognition by the second recognition unit in a case where the degradation information satisfies a predetermined condition B.
2-9. The information processing apparatus according to any one of supplementary notes 2-1 to 2-8, in which
   the state information indicates one or more of an orientation of a face, a body pose, an orientation of a gaze, a movement velocity, and presence or absence of wearing of glasses.
2-10. The information processing apparatus according to any one of supplementary notes 2-1 to 2-9, in which
   the state information further indicates a capture condition of the camera.
2-11. The information processing apparatus according to supplementary note 2-10, in which
   the state information indicates one or more of an exposure time of the camera, a state of lighting for the target, a focal position of the camera, aperture size of a lens of the camera, and brightness of a capture region of the camera.
2-12. The information processing apparatus according to any one of supplementary notes 2-1 to 2-11, in which
   the estimation unit generates the degradation information by use of a trained neural network that has trained by use of the state information and ground truth degradation information.
2-13. The information processing apparatus according to any one of supplementary notes 2-1 to 2-12, in which
   the control unit outputs the control information for executing a notification in a case where the degradation information satisfies a predetermined condition C.
2-14. The information processing apparatus according to any one of supplementary notes 2-1 to 2-13, in which
   the control unit cancels image capture of the target by the camera in a case where the degradation information satisfies a predetermined condition D.
2-15. The information processing apparatus according to any one of supplementary notes 2-1 to 2-14, in which
   the control unit outputs the control information for controlling a capture condition of the camera, based on the degradation information.
3-1. An information processing method including,
   by one or more computers:
      acquiring state information indicating at least a state of a target;
      generating, by use of the state information, degradation information relating to degradation estimated to occur in a target image acquired by capturing an image of the target with a camera; and
      outputting control information according to the degradation information at least one of times before an image of the target is captured with the camera and at which an image of the target is captured with the camera.
3-2. The information processing method according to supplementary note 3-1, in which
   the state information indicates at least a state of the target at a time point at which the target is located at a point farther away than a focus of the camera, and
   the information processing method further including, by the one or more computers, outputting the control information at least one of times before the target reaches the focus of the camera and at which the target reaches the focus of the camera.
3-3. The information processing method according to supplementary note 3-2, further including,
   the one or more computers:
      generating, by use of the state information, state information at capture indicating a result of estimating a state of the target at a time point at which the target reaches the focus of the camera, and
      generating the degradation information by use of the state information at capture.
3-4. The information processing method according to any one of supplementary notes 3-1 to 3-3, in which
   the degradation information indicates one or more degradation factors to occur in the target image and a degree of degradation of each of the one or more degradation factors.
3-5. The information processing method according to supplementary note 3-4, in which
   the target image is an image including an iris, and
   the one or more degradation factors include one or more of focus blur, motion blur, eyelid occlusion, lighting reflection occlusion, and off-angle.
3-6. The information processing method according to any one of supplementary notes 3-1 to 3-5, further including:
   by the one or more computers,
      estimating, by use of the degradation information, quality of the target image, the quality indicating suitability as an image to be used for recognition, and
      outputting the control information according to the quality.
3-7 The information processing method according to supplementary note 3-6, further including,
   by the one or more computers:
      performing recognition by use of the target image; and
      performing recognition by use of information different from the target image, in which
   the one or more computers raise an importance degree of the recognition using information different from the target image, in a case where the quality satisfies a predetermined condition A.
3-8. The information processing method according to any one of supplementary notes 3-1 to 3-7, further including,
   by the one or more computers:
      performing recognition by use of the target image; and
      performing recognition by use of information different from the target image, in which
   the one or more computers raise an importance degree of the recognition using information different from the target image, in a case where the degradation information satisfies a predetermined condition B.
3-9. The information processing method according to any one of supplementary notes 3-1 to 3-8, in which
   the state information indicates one or more of an orientation of a face, a body pose, an orientation of a gaze, a movement velocity, and presence or absence of wearing of glasses.
3-10. The information processing method according to any one of supplementary notes 3-1 to 3-9, in which
   the state information further indicates a capture condition of the camera.
3-11. The information processing method according to supplementary note 3-10, in which
   the state information indicates one or more of an exposure time of the camera, a state of lighting for the target, a focal position of the camera, aperture size of a lens of the camera, and brightness of a capture region of the camera.
3-12. The information processing method according to any one of supplementary notes 3-1 to 3-11, further including,
   by the one or more computers, generating the degradation information by use of a trained neural network that has trained by use of the state information and ground truth degradation information.
3-13. The information processing method according to any one of supplementary notes 3-1 to 3-12, further including,
   by the one or more computers, outputting the control information for executing a notification in a case where the degradation information satisfies a predetermined condition C.
3-14. The information processing method according to any one of supplementary notes 3-1 to 3-13, further including,
   by the one or more computers, canceling image capture of the target by the camera in a case where the degradation information satisfies a predetermined condition D.
3-15. The information processing method according to any one of supplementary notes 3-1 to 3-14, further including,
   by the one or more computers, outputting the control information for controlling a capture condition of the camera, based on the degradation information.
4-1. A computer-readable medium storing a program,
   the program causing a computer to function as:
      an acquisition unit that acquires state information indicating at least a state of a target;
      an estimation unit that generates, by use of the state information, degradation information relating to degradation estimated to occur in a target image acquired by capturing an image of the target with a camera; and
      a control unit that outputs control information according to the degradation information at least one of times before an image of the target is captured with the camera and at which an image of the target is captured with the camera.
4-2. The medium according to supplementary note 4-1, in which
   the state information indicates at least a state of the target at a time point at which the target is located at a point farther away than a focus of the camera, and
   the control unit outputs the control information at least one of times before the target reaches the focus of the camera and at which the target reaches the focus of the camera.
4-3. The medium according to supplementary note 4-2, in which
   the estimation unit
      generates, by use of the state information, state information at capture indicating a result of estimating a state of the target at a time point at which the target reaches the focus of the camera, and
      generates the degradation information by use of the state information at capture.
4-4. The medium according to any one of supplementary notes 4-1 to 4-3, in which
   the degradation information indicates one or more degradation factors to occur in the target image and a degree of degradation of each of the one or more degradation factors.
4-5. The medium according to supplementary note 4-4, in which
   the target image is an image including an iris, and
   the one or more degradation factors include one or more of focus blur, motion blur, eyelid occlusion, lighting reflection occlusion, and off-angle.
4-6. The medium according to any one of supplementary notes 4-1 to 4-5, in which
   the control unit
      estimates, by use of the degradation information, quality of the target image, the quality indicating suitability as an image to be used for recognition, and
      outputs the control information according to the quality.
4-7. The medium according to supplementary note 4-6, in which
   the program further causes the computer to function as
      a first recognition unit that performs recognition by use of the target image, and
      a second recognition unit that performs recognition by use of information different from the target image, and
   the control unit raises an importance degree of recognition by the second recognition unit in a case where the quality satisfies a predetermined condition A.
4-8. The medium according to any one of supplementary notes 4-1 to 4-7, in which
   the program further causes the computer to function as
      a first recognition unit that performs recognition by use of the target image, and
      a second recognition unit that performs recognition by use of information different from the target image, and
   the control unit raises an importance degree of recognition by the second recognition unit in a case where the degradation information satisfies a predetermined condition B.
4-9. The medium according to any one of supplementary notes 4-1 to 4-8, in which
   the state information indicates one or more of an orientation of a face, a body pose, an orientation of a gaze, a movement velocity, and presence or absence of wearing of glasses.
4-10. The medium according to any one of supplementary notes 4-1 to 4-9, in which
   the state information further indicates a capture condition of the camera.
4-11. The medium according to supplementary note 4-10, in which
   the state information indicates one or more of an exposure time of the camera, a state of lighting for the target, a focal position of the camera, aperture size of a lens of the camera, and brightness of a capture region of the camera.
4-12. The medium according to any one of supplementary notes 4-1 to 4-11, in which
   the estimation unit generates the degradation information by use of a trained neural network that has trained by use of the state information and ground truth degradation information.
4-13. The medium according to any one of supplementary notes 4-1 to 4-12, in which
   the control unit outputs the control information for executing a notification in a case where the degradation information satisfies a predetermined condition C.
4-14. The medium according to any one of supplementary notes 4-1 to 4-13, in which
   the control unit cancels image capture of the target by the camera in a case where the degradation information satisfies a predetermined condition D.
4-15. The medium according to any one of supplementary notes 4-1 to 4-14, in which
   the control unit outputs the control information for controlling a capture condition of the camera, based on the degradation information.
5-1 A program causing a computer to function as:
   an acquisition unit that acquires state information indicating at least a state of a target;
   an estimation unit that generates, by use of the state information, degradation information relating to degradation estimated to occur in a target image acquired by capturing an image of the target with a camera; and
   a control unit that outputs control information according to the degradation information at at least one of times before an image of the target is captured with the camera and at which an image of the target is captured with the camera.
5-2. The program according to supplementary note 5-1, in which
   the state information indicates at least a state of the target at a time point at which the target is located at a point farther away than a focus of the camera, and
   the control unit outputs the control information at at least one of times before the target reaches the focus of the camera and at which the target reaches the focus of the camera.
5-3. The program according to supplementary note 5-2, in which
   the estimation unit
      generates, by use of the state information, state information at capture indicating a result of estimating a state of the target at a time point at which the target reaches the focus of the camera, and
      generates the degradation information by use of the state information at capture.
5-4. The program according to any one of supplementary notes 5-1 to 5-3, in which
   the degradation information indicates one or more degradation factors to occur in the target image and a degree of degradation of each of the one or more degradation factors.
5-5. The program according to supplementary note 5-4, in which
   the target image is an image including an iris, and
   the one or more degradation factors include one or more of focus blur, motion blur, eyelid occlusion, lighting reflection occlusion, and off-angle.
5-6. The program according to any one of supplementary notes 5-1 to 5-5, in which
   the control unit
      estimates, by use of the degradation information, quality of the target image, the quality indicating suitability as an image to be used for recognition, and
      outputs the control information according to the quality.
5-7. The program according to supplementary note 5-6,
   further causing the computer to function as
      a first recognition unit that performs recognition by use of the target image, and
      a second recognition unit that performs recognition by use of information different from the target image, in which
   the control unit raises an importance degree of recognition by the second recognition unit in a case where the quality satisfies a predetermined condition A.
5-8. The program according to any one of supplementary notes 5-1 to 5-7,
   further causing the computer to function as
      a first recognition unit that performs recognition by use of the target image, and
      a second recognition unit that performs recognition by use of information different from the target image, in which
   the control unit raises an importance degree of recognition by the second recognition unit in a case where the degradation information satisfies a predetermined condition B.
5-9. The program according to any one of supplementary notes 5-1 to 5-8, in which
   the state information indicates one or more of an orientation of a face, a body pose, an orientation of a gaze, a movement velocity, and presence or absence of wearing of glasses.
5-10. The program according to any one of supplementary notes 5-1 to 5-9, in which
   the state information further indicates a capture condition of the camera.
5-11. The program according to supplementary note 5-10, in which
   the state information indicates one or more of an exposure time of the camera, a state of lighting for the target, a focal position of the camera, aperture size of a lens of the camera, and brightness of a capture region of the camera.
5-12. The program according to any one of supplementary notes 5-1 to 5-11, in which
   the estimation unit generates the degradation information by use of a trained neural network that has trained by use of the state information and ground truth degradation information.
5-13. The program according to any one of supplementary notes 5-1 to 5-12, in which
   the control unit outputs the control information for executing a notification in a case where the degradation information satisfies a predetermined condition C.
5-14. The program according to any one of supplementary notes 5-1 to 5-13, in which
   the control unit cancels image capture of the target by the camera in a case where the degradation information satisfies a predetermined condition D.
5-15. The program according to any one of supplementary notes 5-1 to 5-14, in which
   the control unit outputs the control information for controlling a capture condition of the camera, based on the degradation information.

### REFERENCE SIGNS LIST

10 Information processing apparatus
20 Camera
22 Alternative camera
30 State measurement unit
40 Lighting unit
50 Information processing system
60 Camera for second recognition
70 Notification unit
80 Gate
90 Target
100 Recognition information storage unit
110 Acquisition unit
130 Estimation unit
131, 133 Degradation estimation model
132 Capture timing state estimation model
150 Control unit
151 Quality estimation model
170 First recognition unit
190 Second recognition unit
1000 Computer
1020 Bus
1040 Processor
1060 Memory
1080 Storage device
1100 Input/output interface
1120 Network interface

What is claimed is:

1. An information processing system comprising:
a camera being capable of capturing an image of a target;
at least one memory storing instructions; and
at least one processor configured to execute the instructions to perform operations comprising:
acquiring state information indicating at least a state of the target at a time point at which the target is located at a point farther away from the camera than a focus of the camera;
generating, by use of the state information, state information at capture indicating a result of estimating a state of the target at a time point at which the target reaches in focus of the camera, and
generating, by use of the state information at capture, degradation information relating to degradation estimated to occur in a target image acquired by capturing an image of the target with the camera; and
outputting control information according to the degradation information at at least one of times before an image of the target is captured with the camera and at which an image of the target is captured with the camera.

2. The information processing system according to claim 1, wherein
outputting the control information comprises outputting the control information at at least one of times before the target reaches in focus of the camera and at which the target reaches in focus of the camera.

3. (canceled)

4. The information processing system according to claim 1, wherein
the degradation information indicates one or more degradation factors to occur in the target image and a degree of degradation of each of the one or more degradation factors.

5. The information processing system according to claim 4, wherein
the target image is an image including an iris, and
the one or more degradation factors include one or more of focus blur, motion blur, eyelid occlusion, lighting reflection occlusion, and off-angle.

6. The information processing system according to claim 1, wherein
the operations further comprise estimating, by use of the degradation information, quality of the target image, the quality indicating suitability as an image to be used for recognition, and
outputting the control information comprises outputting the control information according to the quality.

7. The information processing system according to claim 6, wherein the operations further comprise:
a performing first recognition by use of the target image;
performing second recognition by use of information different from the target image; and
raising an importance degree of second recognition in a case where the quality satisfies a predetermined condition A.

8. The information processing system according to claim 1, wherein the operations further comprise:
performing first recognition by use of the target image;
performing second recognition by use of information different from the target image; and
raising an importance degree of second recognition in a case where the degradation information satisfies a predetermined condition B.

9. The information processing system according to claim 1, wherein
the state information indicates one or more of an orientation of a face, a body pose, an orientation of a gaze, a movement velocity, and presence or absence of wearing of glasses.

10. The information processing system according to claim 1, wherein
the state information further indicates a capture condition of the camera.

11. The information processing system according to claim 10, wherein
the state information indicates one or more of an exposure time of the camera, a state of lighting for the target, a focal position of the camera, aperture size of a lens of the camera, and brightness of a capture region of the camera.

12. The information processing system according to claim 1, wherein
generating the degradation information comprises generating the degradation information by use of a trained neural network that accepts an input of the state information at capture and outputs the degradation information.

13. The information processing system according to claim 1, wherein
outputting the control information comprises outputting the control information for executing a notification in a case where the degradation information satisfies a predetermined condition C.

14. The information processing system according to claim 1, wherein
outputting the control information comprises canceling image capture of the target by the camera in a case where the degradation information satisfies a predetermined condition D.

15. The information processing system according to claim 1, wherein
outputting the control information comprises outputting the control information for controlling a capture condition of the camera, based on the degradation information.

16. (canceled)

17. An information processing method comprising,
by one or more computers:
acquiring state information indicating at least a state of a target at a time point at which the target is located at a point farther away from the camera than a focus of the camera;
generating, by use of the state information, state information at capture indicating a result of estimating a state of the target at a time point at which the target reaches in focus of the camera, and
generating, by use of the state information at capture, degradation information relating to degradation estimated to occur in a target image acquired by capturing an image of the target with a camera; and
outputting control information according to the degradation information at at least one of times before an image of target is captured with the camera and at which an image of the target is captured with the camera.

18. A non-transitory computer-readable medium storing a program executable by a computer to perform a control method comprising:
acquiring state information indicating at least a state of a target at a time point at which the target is located at a point farther away from the camera than a focus of the camera;
generating, by use of the state information, state information at capture indicating a result of estimating a state of the target at a time point at which the target reaches in focus of the camera, and
generating, by use of the state information at capture, degradation information relating to degradation estimated to occur in a target image acquired by capturing an image of the target with a camera; and
outputting control information according to the degradation information at at least one of times before an image of the target is captured with the camera and at which an image of the target is captured with the camera.
